(19) United States
(12) Patent Application Publication
(10) Pub. No.: US 2010/0032905 A1
(43) Pub. Date: Feb. 11, 2010

(54) SHOOTING GALLERY DEVICES AND METHODS

(75) Inventors: Tim Morrow, Jefferson City, MO (US); Jacob Dale, Moberly, MO (US); Yan-Jiang Zhou, Columbia, MO (US); Tin Kinney, Columbia, MO (US); Dennis Cauley, Boonville, MO (US); Lucie Liang, Ballwin, MO (US); Russell A. Potterfield, Columbia, MO (US)

Correspondence Address: PERKINS COIE LLP;PATENT-SEA, P.O. BOX 1247, SEATTLE, WA, 98111-1247, US

(73) Assignee: Battenfeld Technologies, Inc., Columbia, MO (US)

(21) Appl. No.: 12/578,393

(22) Filed: Oct. 13, 2009

Related U.S. Application Data
(63) Continuation of application No. 11/679,136, filed on Feb. 26, 2007.
(60) Provisional application No. 60/776,469, filed on Feb. 24, 2006.

(51) Int. Cl. F41J 9/02; F41J 7/04; B23P 11/00

(52) U.S. Cl. 273/366; 273/392; 273/407; 273/359; 29/525.08

(57) ABSTRACT

Shooting gallery devices and methods are disclosed herein. In one embodiment, a shooting gallery includes a plurality of targets rotatably connected to a plurality of target connectors. The targets rotate between an extended position and a fallen position. The target and target connector assembly at least partially retains the targets in the extended position and/or prevents the targets from rotating from the extended position to the fallen position. Furthermore, the targets and target connector assemblies are configured to reset from the fallen position to the extended position without a rail guide or reset cam.

### CROSS REFERENCE TO RELATED APPLICATIONS

This application claims the benefit of U.S. Provisional Patent Application Number 60,776,469, filed Feb. 24, 2006, which is incorporated herein by reference.

### TECHNICAL FIELD

The present disclosure is directed to shooting galleries and methods of operating shooting galleries.

### BACKGROUND

Shooting galleries have existed for many years, providing amateurs and professionals alike the opportunity to shoot a firearm at a moving target for fun, skill, sport, enjoyment, and/or practice. Shooting galleries range from those found at amusement parks using numerous types of projectiles (water, cork, beans, BB's) to galleries designed for high power rifles. Conventional shooting galleries include multiple targets moving on an endless chain or belt in front of a shooter. As the targets pass laterally in front of a shooter, the shooter attempts to hit the targets with a projectile to knock the targets over. When a shooter successfully hits a target, the target temporarily disappears from view. The target then travels around a loop and reappears upright in front of the shooter. Most shooting galleries typically reset the targets by using a complex system including guides, reset cams and target rails to direct the targets upright again. One example of a shooting gallery device requiring a target rail to reset and retain the targets in an upright position along the target track is disclosed in U.S. Pat. No. 6,736,400 issued to Cesternino. These components increase the cost, complexity, size and weight of the gallery. Accordingly, a need exists to improve conventional shooting galleries.

### BRIEF DESCRIPTION OF THE DRAWINGS

FIG. 1 is an isometric view of a shooting gallery in accordance with one embodiment of the invention.

FIG. 2A is a schematic front view, FIG. 2B is a schematic back view, and

FIG. 2C is a schematic side view of a shooting gallery in accordance with an embodiment of the invention. FIG. 2D is a schematic side view of a shooting gallery in accordance with another embodiment of the invention.

FIG. 3A is an isometric view of a target and target connector assembly, and

FIG. 3B is an isometric view of an alternative embodiment of the target. FIG. 3C is an enlarged isometric partial view of a target connector in accordance with an embodiment of the invention. FIG. 3D is an isometric view of an alternative target connector in accordance with an embodiment of the invention.

FIG. 4 is a side view of a portion of a target in accordance with an embodiment of the invention.

FIG. 5 is a cross-sectional view along line 5-5 of FIG. 3A of a target and target connector in accordance with an embodiment of the invention.

FIG. 6 is an isometric view of a protective housing for use with the shooting gallery in accordance with one embodiment of the invention.

FIG. 7 is a partial isometric view of a power cord protection member of the system in accordance with an embodiment of the invention.

### DETAILED DESCRIPTION

### A. Overview

The following disclosure describes several embodiments of shooting galleries. One aspect of the invention is directed to an automatic shooting gallery. In one embodiment, a shooting gallery comprises a first plate, a frame coupled to the first plate, a power source, and a conveyor driven by the power source. The conveyor travels in a predetermined path and includes a shooting zone and a return zone. A plurality of target connectors are coupled to the conveyor. The shooting gallery further comprises a plurality of targets that are movable between an extended position and a fallen position. The targets are pivotally connected to the target connectors, and the target connectors at least partially retain the targets in the extended position when the targets are positioned in the shooting zone. The targets at least partially rest against the target connectors in the extended position during the shooting zone of the path. The targets in the fallen position are configured to reset to the extended position from the fallen position during the return zone of the path without the aid of a resetting mechanism.

In another embodiment, the shooting gallery comprises a support frame, one or more gears rotatably coupled to the frame, a power source coupled to the one or more gears, and a conveyor disposed on the one or more gears. The power source drives the conveyor through a loop including a shooting zone and a return zone. The shooting gallery further includes a plurality of target connectors coupled to the conveyor and a plurality of targets retained by the target connectors. In another embodiment, the individual targets include a sleeve portion that removably and pivotally couples the targets to the individual target connectors. The targets are configured to pivot between extended and fallen positions, and to move laterally across the shooting gallery in a first direction through the shooting zone and in a second direction opposite the first direction through the return zone.

In another embodiment, the shooting gallery includes a target connector assembly including a target having a first portion and a target connector including side portions. The side portions can have an aperture configured to removably receive a pivot member. The first portion of the target is pivotally coupled to the pivot member. The assembly may be configured to increase the force required to pivot the target from an extended position to a fallen position.

In another embodiment, the shooting gallery includes a target connector assembly having a first portion that slidably engages a target connector retention guide rail that is mounted to a support member on the shooting gallery. The target connector may be configured so that the targets do not touch the target connector retention guide rail when they are in the extended position.

Another embodiment of the invention is directed to a method of moving targets across a shooting gallery. The method comprises driving a conveyor with a power source through a cycle having a shooting phase and a return phase, wherein a plurality of target connectors are attached to the conveyor. The method further comprises pivotally connecting individual targets to the plurality of target connectors and moving the targets laterally across the shooting gallery in a first direction during the shooting phase. The targets move in the first direction and rotate between an extended position and a fallen position. The method further comprises moving the targets in a second direction opposite the first direction laterally across the shooting gallery during the return phase. In the return phase targets in the fallen position automatically reset to the extended position without the aid of a resetting device.

Another embodiment of the invention includes a method of connecting a plurality of targets to a shooting gallery. The method comprises attaching a plurality of target connectors to a conveyor that travels in a loop relative to the shooting gallery and pivotally coupling a target to each of the target connectors with a removable pin. The pin is inserted through a sleeve portion of the targets such that the targets rotate about the pin between an extended position and a fallen position. The targets automatically reset from the fallen position to the extended position without contacting any other device.

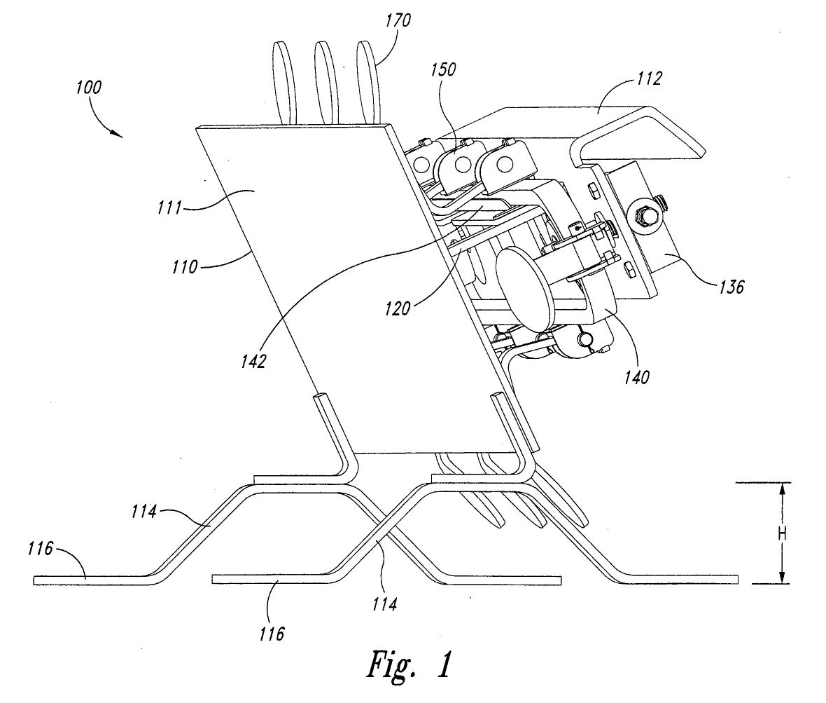

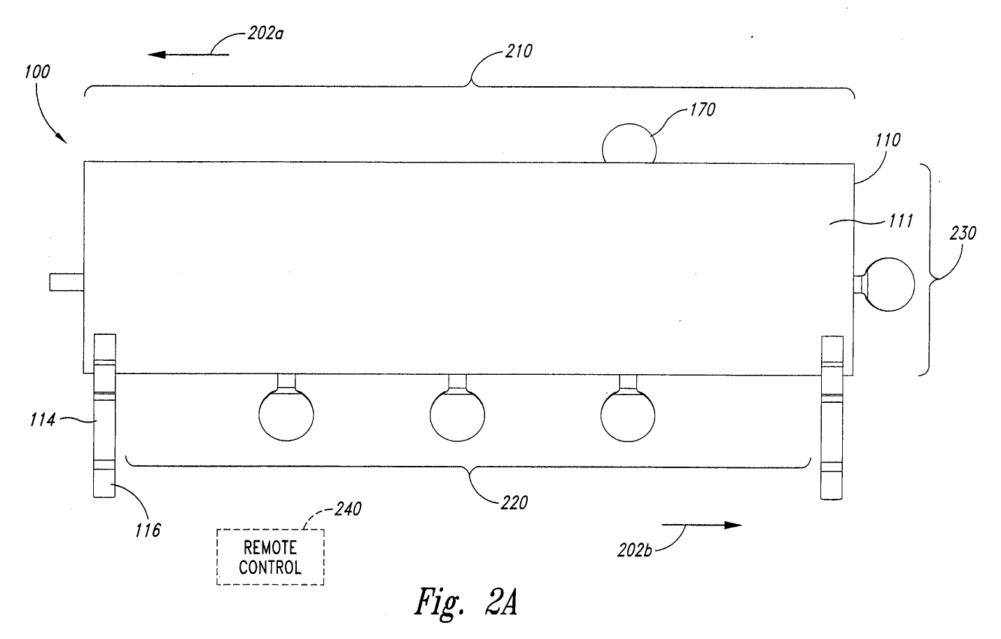

Specific details of several embodiments of the invention are described below with reference to shooting galleries and shooting gallery assemblies. Several details describing well-known structures or processes often associated with shooting galleries are not set forth in the following description for purposes of brevity and clarity. Also, several other embodiments of the invention can have different configurations, components, or procedures than those described in this section. A person of ordinary skill in the art, therefore, will accordingly understand that the invention may have other embodiments with additional elements, or the invention may have other embodiments without several of the elements shown and described below with reference to FIGS. 1-5.

### B. Embodiments of Shooting Galleries

FIG. 1 is an isometric view of a shooting gallery system 100 in accordance with one embodiment of the invention. In this embodiment, the system 100 includes a first plate 110 attached by attachment means 115 to feet 114 and a support frame 120. The first plate 110 protects other components of the system 100 from projectiles fired at the system 100. For example, the first plate 110 is made of a material, such as steel, that can sufficiently withstand a varied caliber of projectiles. The first plate 110 includes a first side 111 that is slightly angled downward to deflect projectiles that strike the first plate 110 toward the ground. In other embodiments, the first plate 110 may include a receptacle (not shown) to catch or collect the deflected projectiles. The feet 114 also include elongated members 116 to provide a stable base for the system 100 to at least partially prevent the system from moving or falling when a projectile strikes the first plate 110. Alternatively, the feet 114 may include spiked or pointed ends (not shown) to facilitate embedding the feet 114 into the ground. The feet 114 have height H to space the system 100 away from the ground. According to alternative embodiments, the feet 114 are removable so that the system 100 is lighter and less bulky to transport. According to other alternative embodiments, the feet attach directly to plate 110 or support frame 120 without attachment means 115.

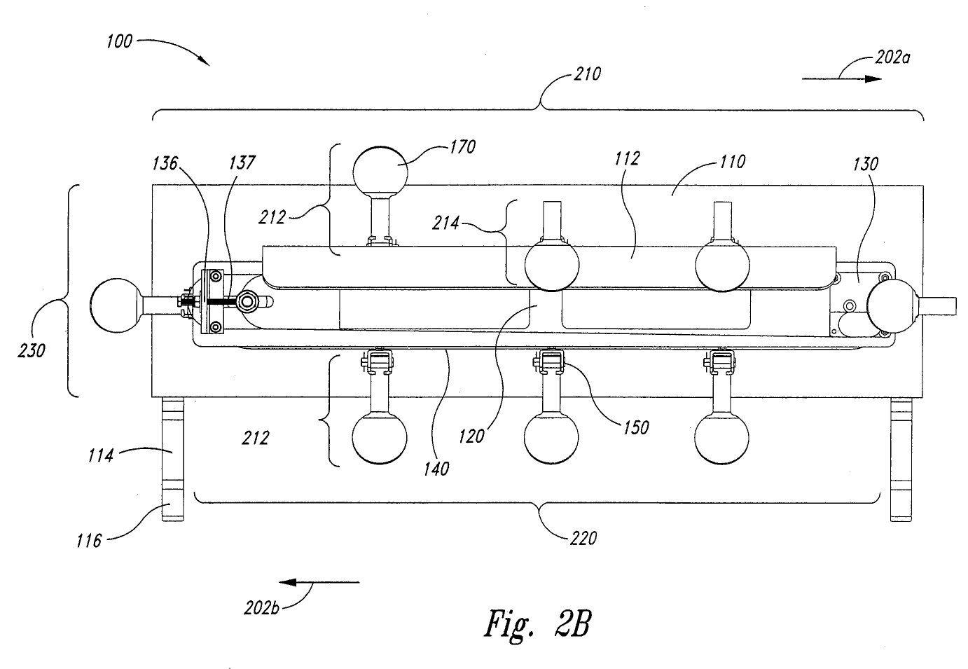

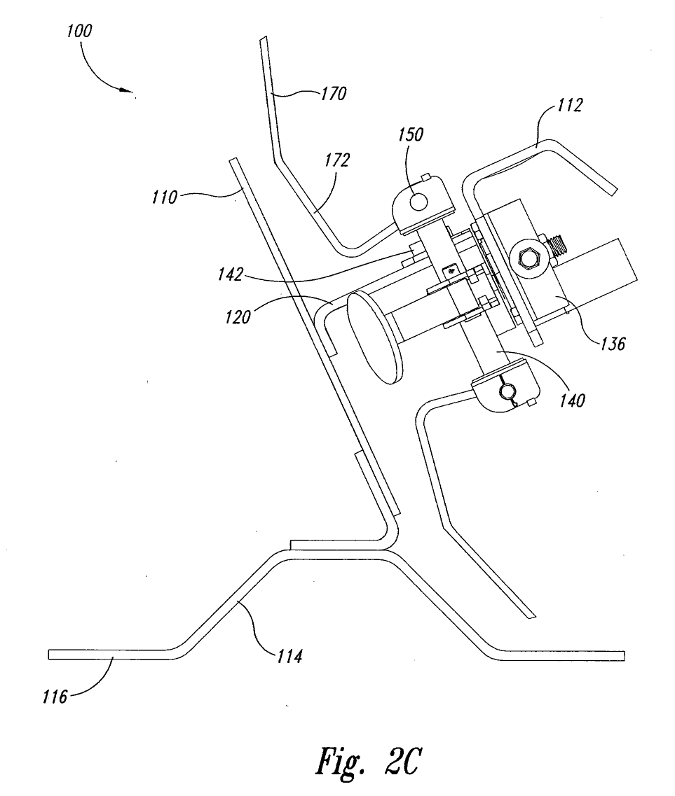

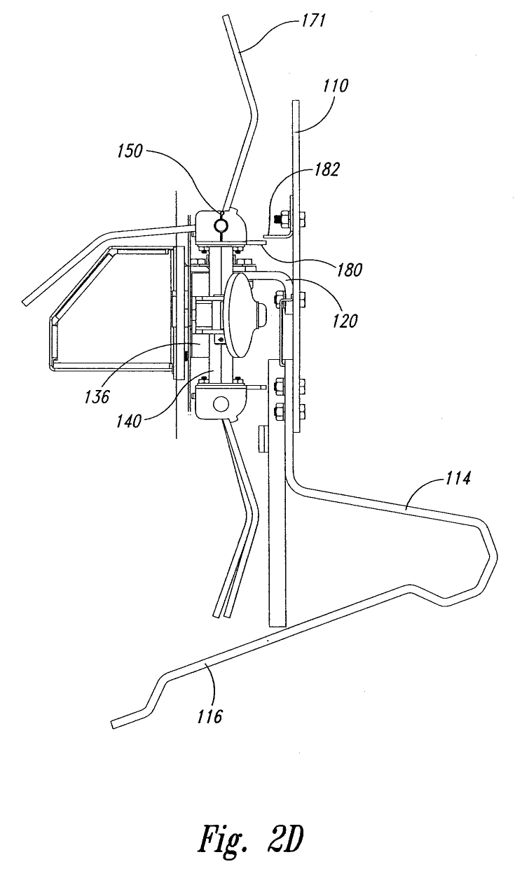

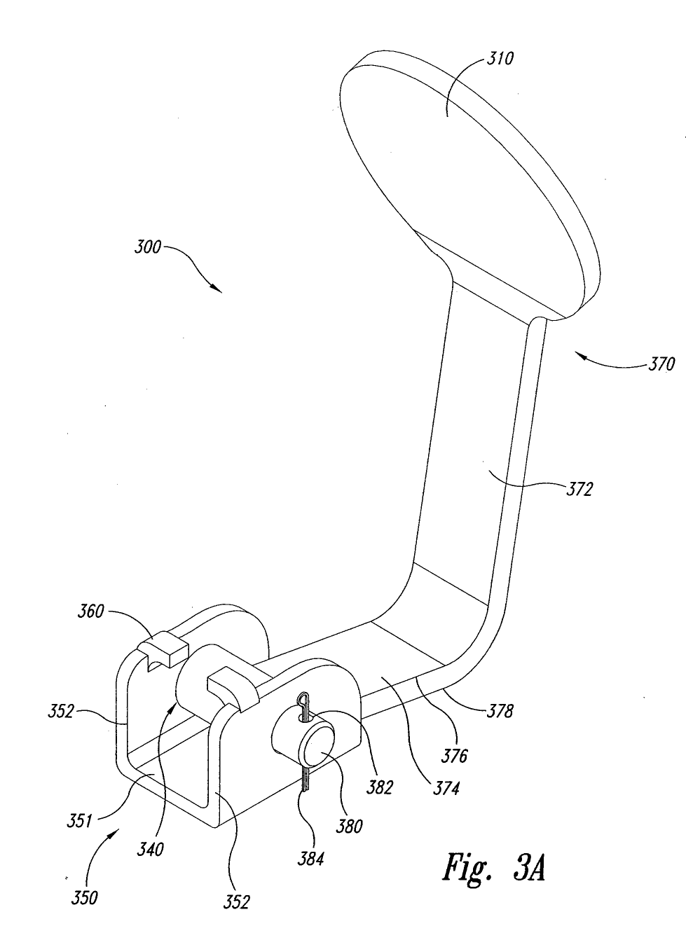

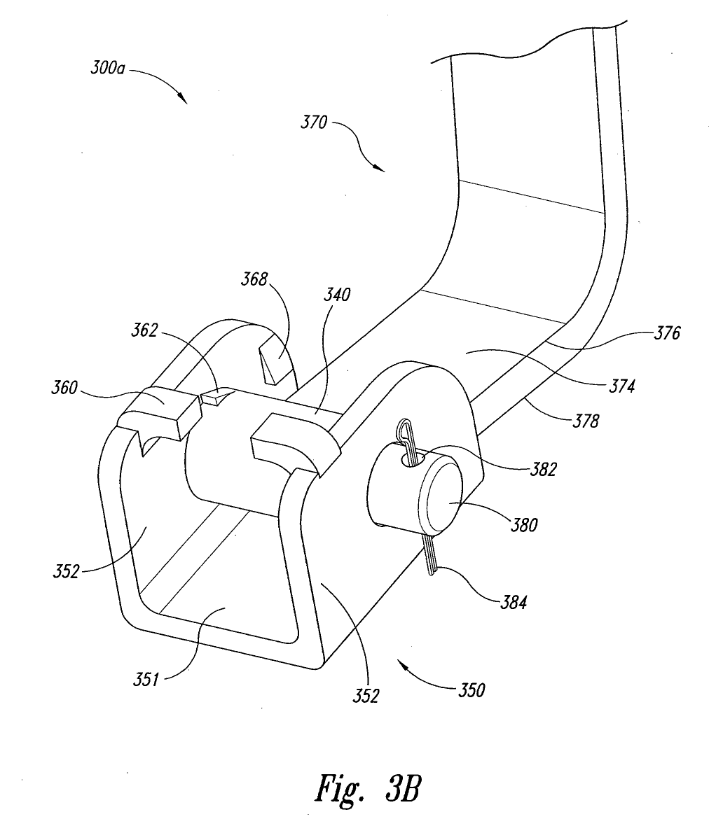

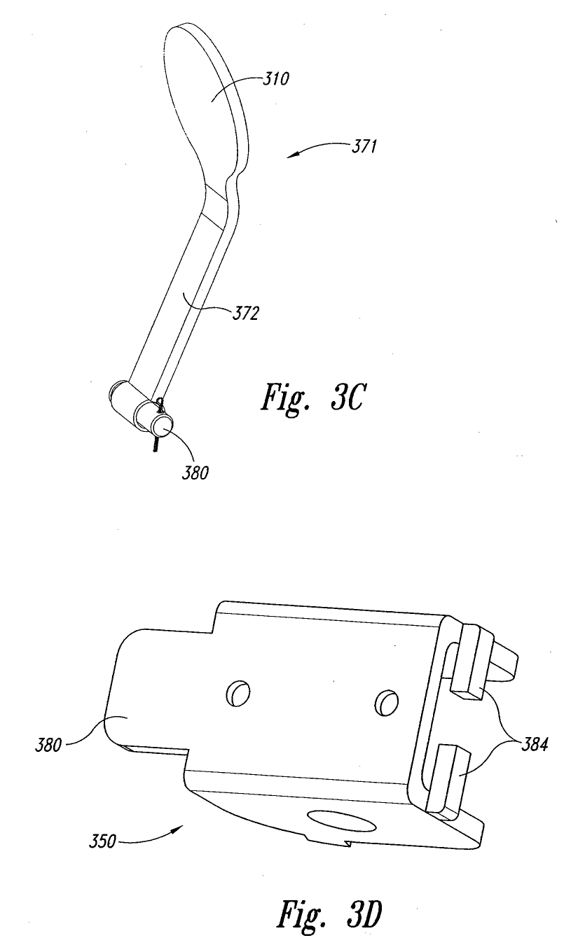

According to one embodiment, the support frame 120 is connected to a power source 130 (shown in FIG. 2B) that drives a conveyer 140. The conveyor 140 is a flexible conveyer that travels around the system 100 in an endless loop along a predefined path, as explained below regarding FIGS. 2A-C. In some embodiments, the conveyer 140 is mounted so that a plane bisecting the conveyer's longest axis is not perpendicular to a horizontal plane. In the embodiment illustrated in FIG. 1, the conveyor is a belt; however, in other embodiments the conveyor may comprise a wire, strap, cable, chain (e.g., a linked chain or roller chain), or any other device suitable for traveling around the system 100. The conveyor 140 travels over one or more gears (not shown) coupled to a tension device 136 attached to the frame 120. The tension device 136 is configured to adjust a tension in the conveyor 140. For example, as illustrated in FIG. 2B, the tension device 136 includes a set screw 137 that can increase or decrease the tension of the conveyor 140. Referring again to FIG. 1, the system 100 further includes a plurality of target connectors 150 attached to the conveyor 140. The target connectors 150 can be brackets, hinges, magnetic couplings, or mechanical or electromechanical connection means as are known in the art. One embodiment of the target connectors 150 are described in more detail below with respect to FIGS. 3A-B. Individual target connectors 150 rotatably and removeably connect to individual targets 170 to move the targets along the predefined path of the conveyor 140.

FIG. 2A is a schematic front view, FIG. 2B is a schematic back view, and

FIG. 2C is a schematic side view of an embodiment of the shooting gallery system 100. Like reference characters refer to like components in FIGS. 2A-C and FIG. 1, and thus the description of such components will not be repeated with reference to FIGS. 2A-C. The difference between FIG. 1 and FIGS. 2A and 2B is that a few of the targets 170 are rotated into a second or fallen position 214. Referring to FIGS. 2A-D, the conveyor 140 moves the target connectors 150 and in turn moves the targets 170 laterally across the system 100 in a first direction 202a in the active zone 210 of the conveyor travel and in a second direction 202b opposite the first direction 202a in a return zone 220 of the conveyor travel. When a target is in the active zone 210 of the conveyor travel, the targets 170 are in a first or extended position 212 such that at least a portion of each target 170 is visible to the shooter when viewing the system 100 from the first side 111. When the shooter fires a projectile and successfully hits a target 170 contained in the active zone 210, the target 170 rotates to the fallen position 214 out of view of the shooter. In the fallen position 214, the targets 170 continue to travel with the conveyor 140 to the return zone 220 of the conveyor travel.

In the return zone 220, gravity maintains the targets in the extended position 212 if not knocked down in the active zone 210. Alternatively, gravity aids in rotating and resetting the targets 170 from the fallen position 214 to the extended position 212 if the targets 170 were knocked down while in the active zone. When rotating in the return zone 220, the targets 170 automatically rotate from the fallen position 214 to the extended position 212. Thus, gravity provides a sufficient force to rotate the targets 170 into a vertical position. In addition, the geometry of the targets 170, which according to embodiments of the invention, provides an eccentric weight over center; the configuration of the target connectors 150; and/or the targets 170, helps in rotating the targets 170 from the fallen position 214 to the extended position 212 without the aid of a target rail or a resetting cam. For example, as illustrated in FIG. 2C, a support portion 172 of the targets 170 is generally parallel with the first plate 110 such that the targets 170 tend to pivot toward the first plate 110 from the fallen position 214 to the extended position 212 in the return zone 220 and also in the active zone 210. In some embodiments, additional weight (not shown) may be attached to the support portion to increase the tendency for the target to assume the extended position.

In operation, the targets 170 travel through a transition zone 230 from the return zone 220 to the active zone 210 in the loop. Because the targets 170 have automatically righted themselves to the extended position 212 in the return zone 220, the targets 170 enter the transition zone 230 in the extended position 212 and travel through the transition zone 230 in the extended position 212. Accordingly, no guide rail, target rail, reset cam or other reset surface or other structure contacting the targets 170 is necessary to reset the targets 170 from the fallen position 214 to the extended position 212. Furthermore, as illustrated in FIG. 2C, the targets 170 are configured to travel through the active zone 210 without a support or contact member contacting the support portion 172 of the targets 170 while in the extended position 212.

Eliminating the need for contact surfaces or structures to reset or support the targets reduces the complexity of the system 100. For example, as described in more detail below, the target connector 150 and target 170 are configured to support the target in both the extended position 212 and the fallen position 214 without requiring contact from other structures or devices. Accordingly, the need is eliminated for contact structures to reset the targets 170 between fallen positions 214 and extended positions 212 or a guide rail or other structure to support the targets 170 as the targets 170 advance through in the active zone 210 results in fewer components of the system. In addition, this configuration reduces the cost and weight of the system 100.

In certain embodiments, the system 100 can further include a wireless remote control unit 240 for controlling the movement of the targets 170 in the system 100. In other embodiments the remote control may be electrically connected to the power source 130 with a wire (not shown) of sufficient length (e.g., 40 feet in a specific embodiment) to provide a safe shooting distance. The remote control 240 can direct the speed and direction of the target 170 movement by controlling the speed and direction of the conveyer 140. For example, the remote control 240 can include a rheostat or potentiometer for speed adjustment. The remote control 240 can also be configured to vary the target speed from a maximum to a minimum over a period of time, such as periods of three seconds in a specific example. The remote control 240 can also be configured to periodically stop the targets from moving. Accordingly, the controller allows a user to adjust the target travel speed according to personal preferences from a safe distance while also providing a dynamic target shooting experience. In alternative embodiments, no remote control is provided and the shooting gallery 100 is operated by a power switch (not shown) contained on the system.

According to alternative embodiments, the system 100 also includes a conveyor guide 142 positioned proximate to the conveyor 140. When the targets 170 rotate from the extended position 212 to the fallen position 214, the targets 170 may cause the conveyor 140 to twist. Accordingly, the conveyor guide 142 can provide support to at least partially prevent the conveyor 140 from twisting.

As shown in FIG. 2D, an integral target connector retaining means retention guide 180 is slideably engaged under retention device 182 when the targets 170 are in the active zone 210. The retention device 182 may include a bracket, angle tab or other mechanical or electromechanical retention device. In operation, retention device 182 prevents the conveyor from twisting during projectile impact. As further shown in FIG. 2D, the feet 114 can be configured in any stabilizing geometric configuration including but not limited to those shown in the drawings.

### C. Target and Target Connector Configuration Embodiments

FIG. 3A is a schematic isometric view of an assembly 300, including a target 370 and target connector 350 in accordance with an embodiment of the invention. The assembly 300 includes a target 370 pivotally connected to a target connector 350. In one embodiment, the target 370 includes a target head 310, upper portion 372, and lower portion 374. The lower portion 374 includes an upper surface 376 and a lower surface 378. The target 370 can be formed of a single piece of material suitable for being shot with guns of varied calibers. For example, the targets 370 can be formed of a single piece of hardened steel. The target 370 may also be formed from several pieces of material. In certain embodiments, the target head 310 may include many different sizes and shapes. For example, as illustrated in FIG. 3A, the target head 310 may include a generally round shape. One skilled in the art will appreciate that other target head 310 shapes may be used, such as animal shapes, face card symbols, bull's-eyes, stars or other geometric shapes.

The target 370 has a plurality of bends between the target head 310, upper portion 372, and lower portion 374, creating a geometry that at least partially assists the target 370 in pivoting from the fallen position to the extended position without the use of any other contact device, as described above. Moreover, the geometry of the target 370 also allows the target head 310 to be oriented generally perpendicular to a projectile source, such as a gun. As shown in FIG. 3B, target 371 may also be formed with a single bend. According to the illustrated embodiment, the target 370 consists of a tubular base portion 380, a target head 310 and a lower portion 372. Alternatively, the target may include a plurality of bends, no bends, a curved and/or straight configuration.

The target 370 is rotatably connected to the target connector 350 to rotate between the extended and fallen positions 212 and 214 described above. According to one embodiment, the target connector 350 includes a bottom surface 351 and sidewalls 352. The sidewalls 352 are spaced apart to allow at least part of the lower portion 374 of the target 370 to rotate between the sidewalls 352. The target connector 350 further includes an aperture 354 in each sidewall 352 to removably receive a pin 380. The pin 380 is inserted through a hollow portion, such as a sleeve 340 or ring of the target 370, to allow the target 370 to rotate about the pin 380 between the extended position and the fallen position. The sleeve 340, lower portion 372, upper portion 374 and target 370 may be integrally formed. Alternatively, the sleeve 340, lower portion 372, upper portion 374 and target 370 may be mechanically fixed together or may be a combination of integral and mechanically fixed.

The pin or tubular portion 380 includes an aperture 382 for inserting a removable retaining member 384, such as a cotter pin, for example. According to alternative embodiments, the target connector 350 also includes a stop 360 to restrict the rotation of the target 370 from the extended position to the fallen position. In certain embodiments, the stop 360 may be integral with the target connector 350, or the stop 360 may be attached to the target connector 350. In certain embodiments, the stop 360 can be located in a manner so as to restrict the rotation of the target 370 from the fallen position to the extended position. In certain embodiments, a stop 360 may be in both positions. As illustrated in FIG. 3A, in the extended position the lower surface 378 of the target 370 rests against the bottom surface 351 of the target connector 350. As the target 370 rotates to the fallen position, the upper surface 376 of the lower portion 374 rests against the stop 360. As the target 370 rotates to the fallen position, the upper surface 376 will contact the stop 360, thus halting the rotation of the target 370. Accordingly, the target 370 is configured to at least partially rotate about the pin 380 inserted into the target connector 350 between the extended and fallen positions 212 and 214. According to alternative embodiments, the target connector 350 can be a bracket, hinge, magnetic coupling, and/or other mechanical or electromechanical connection means.

According to aspects of the embodiment, the configuration of the target 370 and the target connector 350 provides many improvements, offering shooters a variety of advantages over existing shooting galleries. For example, the configuration of the target connectors 350 allows a shooter to change and replace targets as the targets become worn or bent. Moreover, a shooter can change or replace a target without using a tool because the retaining member 384 keeping the pin 380 in the sleeve 340 is easily removable. In addition, a shooter may replace targets with a preferred shape or combine different shapes together, thereby adding variability to the target selection. Furthermore, the configuration of the target 370 and target connector 350 eliminates the need for a contact member or rail to support the target 370 in the extended position during the shooting phase of the conveyor travel or to reset the target from the return phase to the shooting phase.

In certain embodiments, a second plate 112 illustrated in FIGS. 1 and 2B-C supplements the stop 360 in restricting the rotation of the target in the fallen position. For example, referring to FIGS. 1, 2B-C, and 3A, in the fallen position, the upper portion 372 of the targets 370 may contact and rest against the second plate 112, in addition to or in lieu of the stop 360, while the targets 370 move through the active zone 210 in the fallen position. One advantage of the second plate 112 is that the second plate 112 protects the other components of the system from stray projectiles or fragments from projectiles. In addition, as the targets are repeatedly struck with projectiles, the upper portion 372 or target head 310 can bend or deform. As a deformed target travels through the active zone 210 in the fallen position, the second plate 112 protects components of the system and prevents deformed targets from contacting or damaging the components of the system. Furthermore, the second plate 112 can further stabilize the conveyor 140 when a target moves from the extended position to the fallen position. For example, as the stop 360 of the target connector 350 stops the target 370 from rotating, the force of the rotating target 370 can cause the conveyor 140 to twist or move. This twisting motion occasionally causes other targets 370 not struck by a projectile to rotate to the fallen position. Accordingly, at least partially supporting the targets 370 with the second plate 112 in the fallen position helps prevent the conveyor 140 from twisting or moving.

FIG. 3C is a schematic isometric view of a portion of an assembly 300a comprising the target 370 and the target connector 350 in accordance with another embodiment of the invention. Like reference characters refer to like components in FIGS. 3A and 3B and thus the description of such components will not be repeated with reference to the assembly 300a illustrated in FIG. 3C. The assembly 300a includes a retaining device such as a first protrusion 362 on the sleeve 340 of the target 370. The first protrusion 362 is positioned at least proximate to the stop 360 and configured to initially at least partially resist the rotation of the target 370 from the extended position to the fallen position, but not to prevent rotation of the target 370 from the fallen position to the extended position. For example, the first protrusion 362 contacts the stop 360 as the target 370 and sleeve 340 rotate to the fallen position. Accordingly, rotating the first protrusion 362 past the stop 360 to the fallen position requires a sufficiently large initial force, such as the impact force from a projectile, to overcome the resistance of the first protrusion 362. As noted above, the rotational force of a target 370 moving to the fallen position can sometimes cause other targets that have not been struck by a projectile to fall. Accordingly, the first protrusion 362 at least partially retains the targets 370 in the extended position and at least partially prevents other targets 370 not struck by a projectile from rotating to the fallen position from the extended position. FIG. 3D shows an isometric view of an alternative embodiment of a target connector having an integral target connection retaining means 380 for inhibiting but not preventing a target (not shown) from rotating between an extended position and a fallen position. Target connection retaining means 380 may be integral tabs, bracket components, lips or extensions extending from the target connector 350 to engage the protection device 182 (shown in FIG. 2D). FIG. 3D further shows retention tabs 384 for engaging a lower portion of the target (not shown) when the target is in a fallen position.

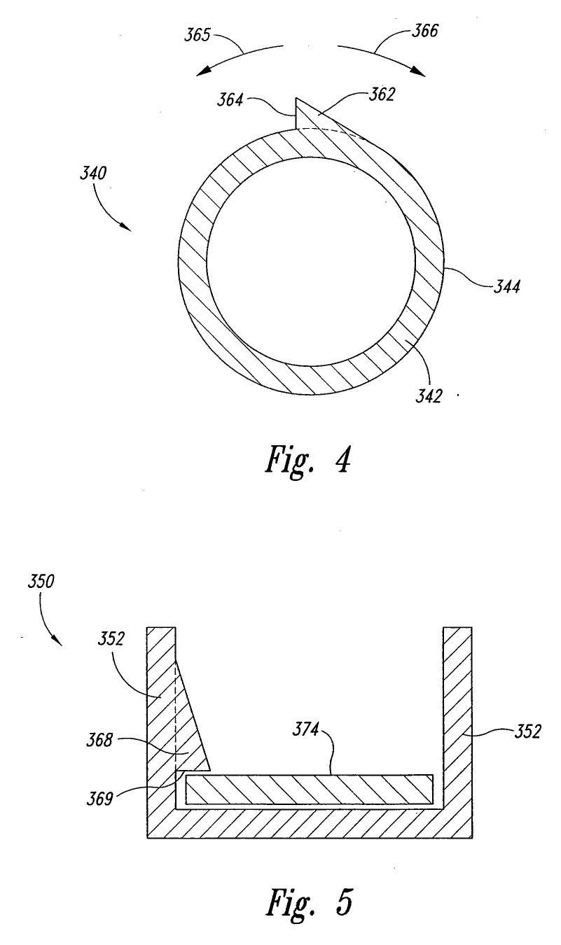

FIG. 4 is a schematic cross-sectional view of the sleeve 340 of FIG. 3B in accordance with another embodiment of the invention. Referring to FIG. 4, the sleeve 340 includes a circular or annular body 342 with an outer surface 344. In certain embodiments, the first protrusion 362 is positioned on the outer surface 344 of the sleeve 340. The first protrusion 362 has a gradually increasing thickness from the outer surface 344 and a contact surface 364. The first protrusion 362 is configured such that the contact surface 364 contacts the stop 360 to initially and at least partially impede rotation of the sleeve 340 in the direction indicated by the arrow 365, which represents the direction of a target rotating from the extended position to the falling position. Moreover, the configuration of the first protrusion 362, including the gradually increasing thickness, allows the sleeve 340 to more easily rotate in the direction indicated by an arrow 366, which represents the direction of a target rotating from the fallen position to the extended position. Accordingly, the first protrusion 362 can at least partially retain the targets in the extended position and at least partially prevent targets that are not struck with a projectile or other unintended targets from rotating from the extended position to the fallen position. In alternative embodiments, the retaining devices can be a magnet, electromagnetic device or a mechanical retention means to retain target assemblies against certain forces.

Referring again to FIG. 3B, one embodiment of the assembly 300a also includes a second retaining device such as a protrusion 368 on the sidewall 352 of the target connector 350. The second protrusion 368 may be positioned at least proximate to the lower portion 374 of the target 370 and is configured similarly to the first protrusion 362 of the sleeve 340, to initially and at least partially resist the rotation of the target to the fallen position, unless a sufficient impact force, for example from a projectile, is applied to the target head 310. The second protrusion 368 contacts the lower portion 374 of the target 370 as the target 370 rotates, and accordingly at least partially retains the targets in the extended position. In alternative embodiments, the second retaining device can be a magnet, an electromagnetic device or a mechanical retention means to retain target assemblies against certain forces.

FIG. 5 is a schematic cross-sectional view of the target connector 350 and second protrusion 368 configuration of FIG. 3B in accordance with an embodiment of the invention. Referring to FIG. 5, the lower portion 374 of the target 370 is positioned between the sidewalls 352 of the target connector 350. The second protrusion 368 is positioned on the sidewall 352 and at least proximate to the lower portion 374 of the target 370. The second protrusion 368 has a gradually increasing thickness from the sidewall 352 and also includes a contact surface 369, similar to the first protrusion 362 illustrated in FIG. 4. The second protrusion 368 is configured such that the contact surface 369 contacts the upper surface 376 of the lower portion 374 of the target 370 to initially and at least partially impede rotation of the target 370 from the extended position to the fallen position. Similar to the first protrusion 362, the second protrusion 368 allows the lower portion 374 to more easily rotate past the second protrusion 368 in the direction toward the extended position from the fallen position.

Furthermore, one skilled in the art will appreciate that in certain embodiments the first protrusion 362 and the second protrusion 368 may be combined, while for other embodiments it may be beneficial to employ only one of the protrusions. Accordingly, the second protrusion 368 can at least partially retain the targets in the extended position and at least partially prevent targets that are not struck with a projectile or other unintended targets from rotating from the extended position to the fallen position.

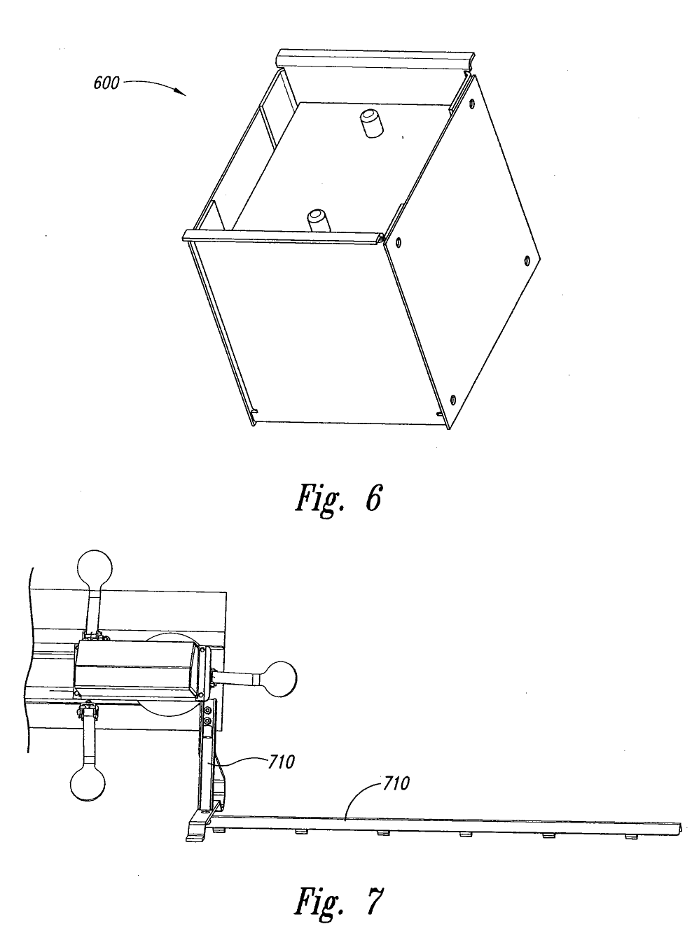

FIG. 6 is an isometric view of a protective housing 600 for use with the shooting gallery. In certain embodiments, wires that connect a battery or remote control are shielded from projectiles with cable shields, shown in FIG. 7. FIG. 7 illustrates power cord protection members 710 adjacent to the power cord (not shown) and positioned to protect the power cord from stray projectiles. The power cord protection members 710 are shown as angles, however, as understood by one skilled in the art, the protection member 710 could be U-shaped, C-shaped, tubular or the like. Furthermore, the protection member 710 can be made of any material suitable to protect the power cord from a projectile.

### D. Conclusion

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number, respectively. When the claims use the word “or” in reference to a list of two or more items, that word covers all of the following interpretations of the word: any of the items in the list, all of the items in the list, and any combination of the items in the list.

The above detailed descriptions of embodiments of the invention are not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform steps in a different order. The various embodiments described herein can be combined to provide further embodiments.

In general, the terms used in the following claims should not be construed to limit the invention to the specific embodiments disclosed in the specification, unless the above detailed description explicitly defines such terms. While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the invention can be modified, if necessary, to employ shooting galleries, targets and target supports with various configurations, and concepts of the various patents, applications, and publications to provide yet further embodiments of the invention.

These and other changes can be made to the invention in light of the above-detailed description. In general, in the following claims, the terms used should not be construed to limit the invention to the specific embodiments disclosed in the specification and the claims, but should be construed to include all shooting galleries, targets and target supports that operate in accordance with the claims. Accordingly, the invention is not limited by the disclosure, but instead its scope is to be determined entirely by the following claims.

1. An automatic shooting gallery, comprising:
a first plate;
a support frame coupled to the first plate;
a power source;
a conveyor driven by the power source, wherein the conveyor travels in a predetermined path having an active zone and a return zone;
a plurality of target connectors coupled to the conveyor; and
a plurality of targets being movable between an extended position and a fallen position, the targets are rotatably connected to the target connectors, wherein the target connectors at least partially retain the targets in the extended position in the active zone of the path, and wherein the targets in the fallen position are configured to reset to the extended position from the fallen position during the return zone of the path without the aid of any other mechanism.

2. The shooting gallery of claim 1, further comprising a second plate coupled to the frame, wherein the targets at least partially rest against the second plate in the fallen position in the active zone.

3. The shooting gallery of claim 1 wherein each target connector comprises a protrusion at least partially retaining the targets in the extended position.

4. The shooting gallery of claim 3 wherein the target connectors further include protrusions configured to at least partially resist rotating the targets from the extended position to the fallen position, such that a first force is required to move the targets from the extended position past the protrusions to the fallen position, and a second force is required to reset the targets from the fallen position past the protrusions to the extended position, and wherein the first force is greater than the second force.

5. The shooting gallery of claim 4 wherein the first force comprises an impact force of a projectile.

6. The shooting gallery of claim 4 wherein the second force comprises gravity.

7. The shooting gallery of claim 1 wherein each target connector comprises a stop, wherein the stop at least partially supports the targets in the fallen position in the active zone.

8. The shooting gallery of claim 1 wherein:
each target connector further includes a sleeve configured to receive a rotation device, the sleeve further configured to receive a locking removable pin.

9. The shooting gallery of claim 8 wherein the sleeve is integral with the target.

10. The shooting gallery of claim 1 wherein the targets are removable without the use of a tool.

11. The shooting gallery of claim 1, further comprising an adjustable conveyor tensioning device.

12. The shooting gallery of claim 1 wherein the power source is configured to drive the conveyor at different speeds.

13. The shooting gallery of claim 1, further comprising a remote control for directing the power source.

14. The shooting gallery of claim 13 wherein the remote control is wireless.

15. The shooting gallery of claim 1, further comprising a conveyor guide positioned proximate to the conveyor, wherein the conveyor guide at least partially maintains the conveyor on the predetermined path when the targets move from the extended position to the fallen position.

16. The shooting gallery of claim 1 wherein the plurality of targets further comprise shooting surfaces having different shapes.

17. The shooting gallery of claim 1 wherein a geometry of the targets distributes a target weight such that the target weight at least partially retains the targets in the extended position.

18. The shooting gallery of claim 1 wherein the shooting gallery is sized to allow a user to hand carry the gallery.

19. An automatic shooting gallery, comprising:
a frame;
one or more gears rotatably coupled to the frame;
a power source coupled to the one or more gears;
a conveyor disposed on the one or more gears, wherein the power source drives the conveyor through a loop comprising an active zone and a return zone;
a plurality of target connectors coupled to the conveyor; and
a plurality of targets, wherein individual targets comprise a bracket that removably and pivotally couples the targets to the individual target connectors, and wherein the targets are configured to rotate between extended and fallen positions and wherein the bracket is configured to at least partially retain the targets in the extended position in the active zone.

20. The shooting gallery of claim 19, further comprising a conveyor guide member and an adjustable conveyor tensioning device proximate to the conveyor, wherein the conveyor guide member at least partially stabilizes the conveyor when a target rotates from the extended position to the fallen position.

21. The shooting gallery of claim 19 wherein the bracket further includes a protrusion for at least partially retaining the targets in the extended position.

22. The shooting gallery of claim 21 wherein the protrusion is configured to at least partially resist rotating the targets from the extended position to the fallen position, such that a first force is required to move the targets from the extended position to the fallen position, and a second force is required to reset the targets from the fallen position to the extended position, and wherein the first force is greater than the second force.

23. (canceled)

24. The shooting gallery of claim 19 wherein the targets further comprise a geometry configured to at least partially rotate the targets from the fallen position to the extended position.

25. The shooting gallery of claim 19 wherein the targets comprise different shapes.

26. The shooting gallery of claim 19, further comprising a remote control, wherein the remote control is configured to control a variable speed of the conveyor.

27. The shooting gallery of claim 26 wherein the remote control is wireless.

28. A target connector assembly for a shooting gallery, the assembly comprising:
a target including a first portion; and
a target connector comprising side portions, each side portion having an aperture configured to removably receive a rotation member, wherein the first portion of the target is rotationally coupled to the rotation member and the assembly is configured to at least partially prevent the target from rotating from a first position to a second position.

29. The assembly of claim 28 wherein the first portion includes a sleeve, and the rotation member is removably inserted through the sleeve.

30. The assembly of claim 28 wherein:
the target further comprises a second portion; and
the target connector further comprises a first protrusion and a second protrusion, wherein the first protrusion is configured to at least partially contact the second portion of the target and at least partially resist rotation of the target from the first position to the second position, and the second protrusion is configured to contact the second portion to stop the rotation of the target from the first position to the second position and to support the second portion of the target in the second position.

31. The assembly of claim 28 wherein the target further comprises a protrusion on the first portion, wherein the protrusion at least partially contacts a portion of the target connector to at least partially resist rotating the target from the first position to the second position.

32. A method of moving targets across a shooting gallery, the method comprising:
driving a conveyor with a power source through a cycle having a shooting phase and a return phase, wherein a plurality of target connectors are attached to the conveyor;
pivotally connecting individual targets to the plurality of target connectors;
moving the targets laterally across the shooting gallery in a first direction during the shooting phase, wherein the targets move in the first direction and rotate between an extended position and a fallen position; and
moving the targets in a second direction opposite the first direction laterally across the shooting gallery during the return phase, wherein in the return phase targets in the fallen position automatically reset to the extended position without the aid of any device and targets in the extended position remain in the extended position without the aid of any device.

33. The method of claim 32, further comprising at least partially retaining the targets in the extended position.

34. The method of claim 33, wherein:
pivotally connecting individual targets to the plurality of target connectors comprises inserting a removable pin through the target connectors and through a sleeve portion of the targets; and
at least partially retaining the targets in the extended position comprises configuring the sleeve portion to at least partially resist rotating the targets from the extended position to the fallen position.

35. The method of claim 33, wherein:
pivotally connecting individual targets to the plurality of target connectors comprises inserting a removable pin through the target connectors and through a sleeve portion of the targets; and
at least partially retaining the targets in the extended position comprises configuring the target connectors to at least partially resist rotating the targets from the extended position to the fallen position.

36. The method of claim 32, further comprising impacting the targets with a projectile to rotate the targets from the extended position to the fallen position.

37. The method of claim 32, further comprising supporting the targets in the fallen position with a stop on the target connectors.

38. The method of claim 32, further comprising at least partially supporting the targets in the fallen position during the shooting phase with a support member positioned proximate to the power source.

39. The method of claim 32 wherein driving the conveyor with a power source comprises directing the power source with a remote control to drive the conveyor at one or more speeds.

40. A method of connecting a plurality of targets to a shooting gallery, the method comprising:
attaching a plurality of target connectors to a conveyor that travels in a continuous loop relative to the shooting gallery; and
rotatably coupling a target to each of the target connectors with a removable pin, wherein the pin is inserted through a bracket coupled to the targets, such that the targets rotate between an extended position and a fallen position, and wherein the targets automatically reset from the fallen position to the extended position without contacting any other device.

41. The method of claim 40 wherein the targets at least partially resist rotating from the extended position to the fallen position.

42. The method of claim 40 wherein the target connectors at least partially resist rotating the targets from the extended position to the fallen position.
